(19) United States
(12) Patent Application Publication
(10) Pub. No.: US 2014/0286230 A1
(43) Pub. Date: Sep. 25, 2014

(54) COMMUNICATION RELAY APPARATUS, MOBILE COMMUNICATION TERMINAL, AND RADIO BASE STATION

(71) Applicant: FUJITSU LIMITED, Kawasaki-shi (JP)

(72) Inventor: AKIRA HIRATA, Yokohama (JP)

(73) Assignee: FUJITSU LIMITED, Kawasaki-shi (JP)

(21) Appl. No.: 14/161,644

(22) Filed: Jan. 22, 2014

(30) Foreign Application Priority Data
Mar. 19, 2013 (JP) 2013-056679

(51) Int. Cl. H04W 40/22

(52) U.S. Cl. CPC H04W 40/22
USPC 370/315

(57) ABSTRACT

A communication relay apparatus includes a mobile communication terminal mapping table manager configured to manage a terminal mapping table, a base station mapping table manager configured to manage a base station mapping table, and a transferring processor configured to: establish a communication path between a mobile communication terminal and a radio base station based on the respective mapping tables; and perform a transferring process of communication data between the mobile communication terminal and the radio base station through the communication path.

### CROSS-REFERENCE TO RELATED APPLICATION

This application is based upon and claims the benefit of priority of the prior Japanese Patent Application No. 2013-056679, filed on Mar. 19, 2013, the entire contents of which are incorporated herein by reference.

### FIELD

The embodiment discussed herein is directed to a communication relay apparatus, a mobile communication terminal, and a radio base station.

### BACKGROUND

In the third generation partnership project (3GPP), a functional outline of a home evolved NodeB (HeNB) is being standardized as a long term evolution (LTE) small-sized base station. The HeNB is a communication base station which is installed, for example, indoors, and establishes a relatively narrow communication area compared to an evolved NodeB (eNB). For example, techniques related to radio communication systems are disclosed in Japanese Laid-open Patent Publication No. 2012-49643, Japanese Laid-open Patent Publication No. 2011-166583, and Japanese Laid-open Patent Publication No. 2009-147956.

An application area of the HeNB overlaps that of a communication base station that supports a wireless local area network (LAN) such as WiFi which is standardized by the WiFi Alliance, and competition may occur. Meanwhile, mobile communication terminals that support communication schemes of both of the LTE and the WiFi have been currently known. In order to support such terminals, it is desirable to install a communication base station which supports the LTE and a communication base station which supports the WiFi.

However, when a plurality of communication base stations are installed, there is a problem in that the cost of the base stations may increase and that installation places for the base stations may be limited. For this reason, the importance of communication base stations that support both of the LTE and the WiFi has been increased.

### SUMMARY

An aspect of a communication relay apparatus includes a mobile communication terminal mapping table manager configured to manage a terminal mapping table in which identification information of a mobile communication terminal is associated with information related to a transmission source of terminal registration request information transmitted by the mobile communication terminal, a base station mapping table manager configured to manage a base station mapping table in which identification information of a radio base station is associated with a transmission source of base station registration request information transmitted by the radio base station, and a transferring processor configured to establish a communication path between the mobile communication terminal and the radio base station based on the respective mapping tables and perform a transferring process of communication data between the mobile communication terminal and the radio base station through the communication path.

An aspect of a mobile communication terminal is a mobile communication terminal configured to communicate with a radio base station through a communication path established by the communication relay apparatus and support a plurality of communication schemes, and includes a terminal registration request transmitting processor configured to transmit the terminal registration request information, a radio quality obtaining processor configured to obtain information related to a surrounding radio quality, a radio quality transmitting processor configured to transmit the obtained information to the radio base station, and a switching control processor configured to switch the communication scheme according to a communication scheme determined by the radio base station based on the radio quality and information related to a communication load of the radio base station.

An aspect of a radio base station is a radio base station configured to communicate with a mobile communication terminal through a communication path established by the communication relay apparatus and support a plurality of communication schemes, and includes a base station registration request transmitting processor configured to transmit the base station registration request information, a terminal registration request transmitting processor configured to transmit the terminal registration request information, a registering processor configured to register the terminal registration request information to a management table upon receiving the terminal registration request information transmitted by the mobile communication terminal from the communication relay apparatus through the communication path, and a controller configured to control, upon receiving information from the communication relay apparatus through the communication path, a communication scheme of the mobile communication terminal based on the received information related to a radio quality around the mobile communication terminal obtained in the mobile communication terminal which is a transmission source of the terminal registration request information registered to the management table and information related to a communication load of the radio base station.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a concept of establishing a communication path between a radio base station (cognitive femto) and a mobile communication terminal (cognitive UE);

FIG. 2 is a diagram illustrating a concept of establishing a communication path between a cognitive femto and a cognitive UE;

FIG. 3 is a diagram illustrating a concept of establishing a communication path between a cognitive femto and a cognitive UE;

FIG. 4 is a diagram illustrating a concept of establishing a communication path between a cognitive femto and a cognitive UE;

FIG. 5 is a diagram illustrating a concept of establishing a communication path between a cognitive femto and a cognitive UE;

FIG. 6 is a diagram illustrating a communication relay process concept between a cognitive femto and a cognitive UE through a communication relay apparatus (cognitive server);

FIG. 7 is a diagram illustrating a communication relay process concept between a cognitive femto and a cognitive UE by a cognitive server;

FIG. 8 is a diagram illustrating a communication relay process concept between a cognitive femto and a cognitive UE by a cognitive server;

FIG. 9 is a diagram illustrating a communication relay process concept between a cognitive femto and a cognitive UE by a cognitive server;

FIG. 10 is a diagram illustrating an exemplary cognitive UE registration sequence;

FIG. 11 is a diagram illustrating an exemplary radio quality update process (sequence);

FIG. 12 is a flowchart illustrating an exemplary switching determination process in a cognitive femto;

FIG. 13 is a flowchart illustrating an exemplary switching determination process in a cognitive femto;

FIG. 14 is a flowchart illustrating an exemplary switching determination process in a cognitive femto;

FIG. 15 is a diagram illustrating an exemplary switching control sequence performed by a cognitive femto;

FIG. 16 is a functional block diagram illustrating a cognitive server;

FIG. 17 is a functional block diagram illustrating a cognitive femto; and

FIG. 18 is a functional block diagram illustrating a cognitive UE.

### DESCRIPTION OF EMBODIMENT

Hereinafter, an exemplary embodiment of the present invention will be described with reference to the appended drawings. However, the following embodiment is mere an example, and not intended to exclude applications of various modifications or techniques which are not set forth below. In the drawings used in the following embodiment, like parts are denoted by like reference numerals unless otherwise set forth herein.

When both of a radio base station and a mobile communication terminal support both of the LTE and the WiFi, it is preferable that a communication terminal positioned in a communication area of the radio base station selects and uses a scheme capable of securing a high communication quality between the LTE and the WiFi.

The communication quality of the mobile communication terminal depends on radio field intensity of the radio base station received by the mobile communication terminal, a communication scheme used by the radio base station and how much the radio base station uses the corresponding communication scheme, or the like. When information related to the communication quality is shared between the radio base station and the mobile communication terminal, and when a communication scheme to be used by the mobile communication terminal is determined based on the information, the mobile communication terminal would be able to select and use a communication scheme by which high-quality communication is available.

A problem of “selection of a communication scheme by which a mobile communication terminal would be able to obtain a high communication quality” is a local problem in a radio base station area in which the corresponding mobile communication terminal is positioned. For this reason, the embodiment set out below employs a policy in which the radio base station collects information from the mobile communication terminal positioned in the communication area of the radio base station and determines a communication scheme to be used by the mobile communication terminal.

Hereinafter, a radio base station which is available to collect information from a mobile communication terminal and is available to determine a communication scheme to be used by the mobile communication terminal may be referred to as a cognitive femto. Further, a mobile communication terminal which is available to provide information to the cognitive femto and is available to receive a determination of a communication scheme to be used may be referred to as a cognitive UE.

In order to use a communication scheme determined by the cognitive femto, the cognitive UE performs the following processes:

(1) the cognitive femto collects information of the cognitive UE;

(2) the cognitive femto determines a communication scheme to be used by each cognitive UE based on the collected information; and

(3) the cognitive femto notifies the cognitive UE of the communication scheme to be used.

In the present embodiment, in order to perform the above-described processes, the followings are implemented:
for the processes of (1) and (3), establishment of a communication path through which information is transmitted and received between the cognitive femto and the cognitive UE; and
for the process of (2), an algorithm by which the cognitive femto determines a communication scheme to be used by the cognitive UE.

(Establishment of Communication Path)

Regarding the communication path through which information is transmitted or received, it is substantially unavailable to directly transceive information merely using a radio section between the cognitive femto and the cognitive UE. It is because, according to the specification of 3GPP, in the LTE, the radio base station is available to merely transceive a control signal directly in the radio section with the mobile communication terminal connected thereto, and it is unavailable for the radio base station to transceive user data. The radio base station is also unavailable to intercept the content of user data transceived between the mobile communication terminal and another node on a network, or intercept dedicated information of the mobile communication terminal.

It may also be considered a technique of performing a WiFi communication at the same time even during an LTE communication and transmitting LTE-related quality information or dedicated information of the mobile communication terminal to the radio base station. However, under an operating system (OS) currently employed in the mobile communication terminal, the LTE communication and the WiFi communication are exclusively performed, and thus it is unavailable to use both of the LTE communication and the WiFi communication at the same time.

Since it is unavailable to transceive information, merely through the radio section, between the cognitive UE and the cognitive femto that are performing the LTE communication, for example, it may be considered a technique of transceiving information by using a wired section. However, when a wired section via the Internet is used, there is a technical problem that the cognitive femto requests an access start to the cognitive UE and that the cognitive UE requests an access start to the cognitive femto.

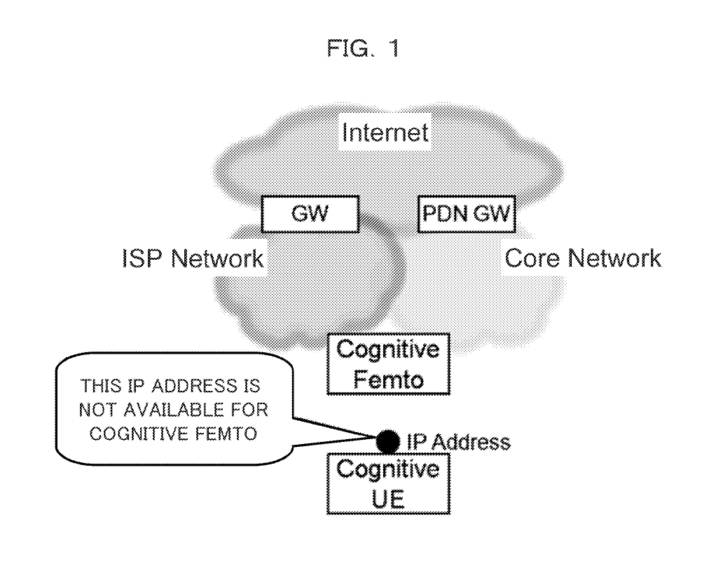

The cognitive UE is allocated an Internet protocol (IP) address used in a mobile operator core network from a mobile operator for the LTE communication. However, the IP address allocated to the cognitive UE corresponds to dedicated information of the cognitive UE, which information is unavailable for the cognitive femto (see FIG. 1).

For this reason, it is unavailable for the cognitive femto to request the cognitive UE to start communication using the IP address. Even though the cognitive femto could recognize the IP address of the cognitive UE in some way, it is not guaranteed that the corresponding IP address is reachable from the cognitive femto (accessible from another general communication device).

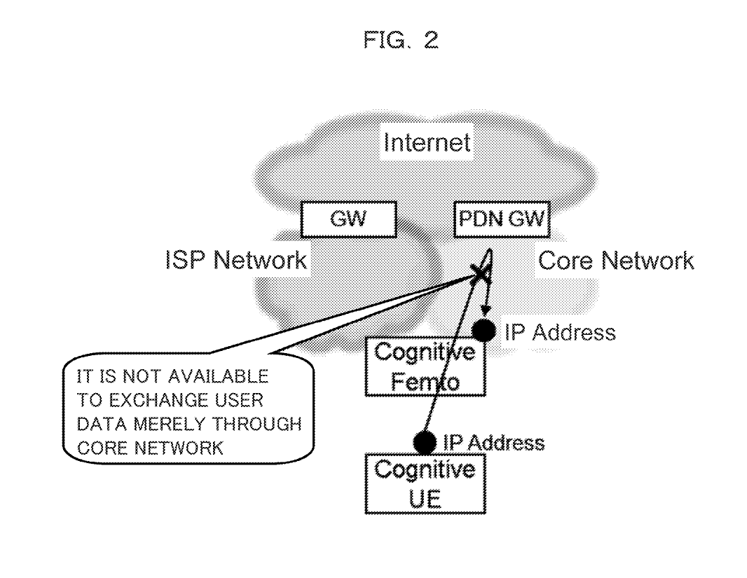

In FIG. 1, a GW represents a gateway between the Internet and an ISP network provided by an Internet service provider (ISP). Further, a packet data network (PDN) GW represents a gateway between the Internet and the core network (mobile operator core network). Such notation method is similarly applied in FIGS. 2 to 9.

The cognitive femto is also allocated an IP address used in the mobile operator core network from the mobile operator, similarly to the cognitive UE. Even though the cognitive UE could recognize the IP address allocated to the cognitive femto, it is unavailable for the cognitive UE to transmit user data to the IP address merely through the mobile operator core network (see FIG. 2).

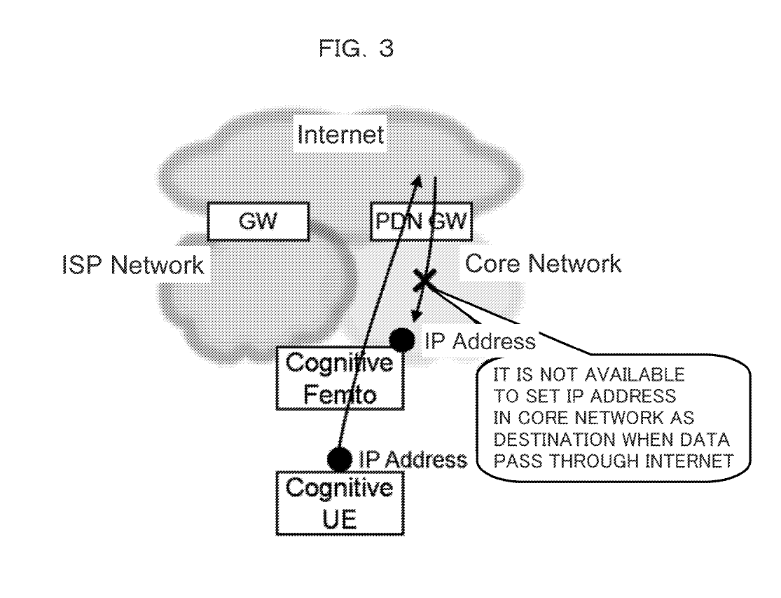

The user data used in the cognitive UE is transmitted to the Internet via the PDN GW. Since the IP address allocated from the mobile operator core network is directed to use within the mobile operator core network, it is unavailable to use the IP address as the destination of communication via the Internet (see FIG. 3). Originally, even though the IP address is allocated from the mobile operator core network, it is not guaranteed that a system of IP address allocated to the UE is the same as a system of IP address allocated to the HeNB.

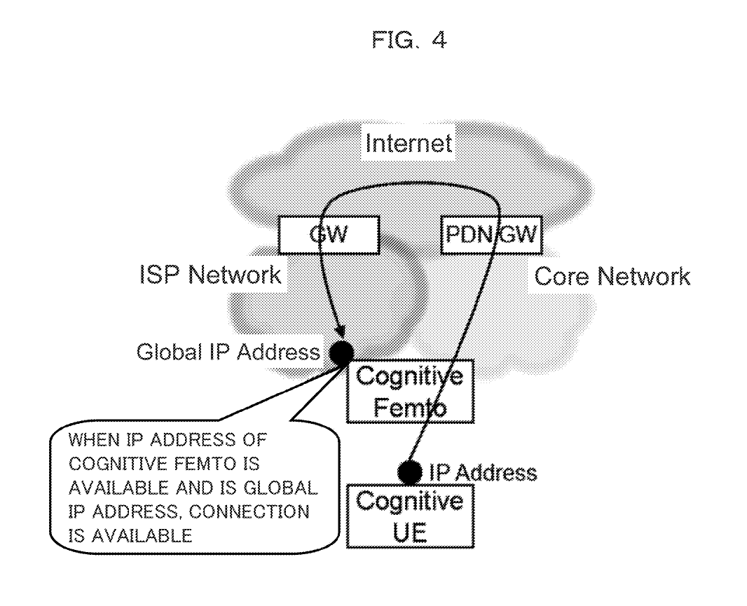

Further, in order to support the WiFi, the cognitive femto is allocated an IP address reachable from the Internet service provider (ISP) or the like. If the IP address is a global IP address and the cognitive UE is able to recognize the global IP address, the cognitive UE could establish a communication path for transceiving information by requesting the cognitive femto to start communication (see FIG. 4).

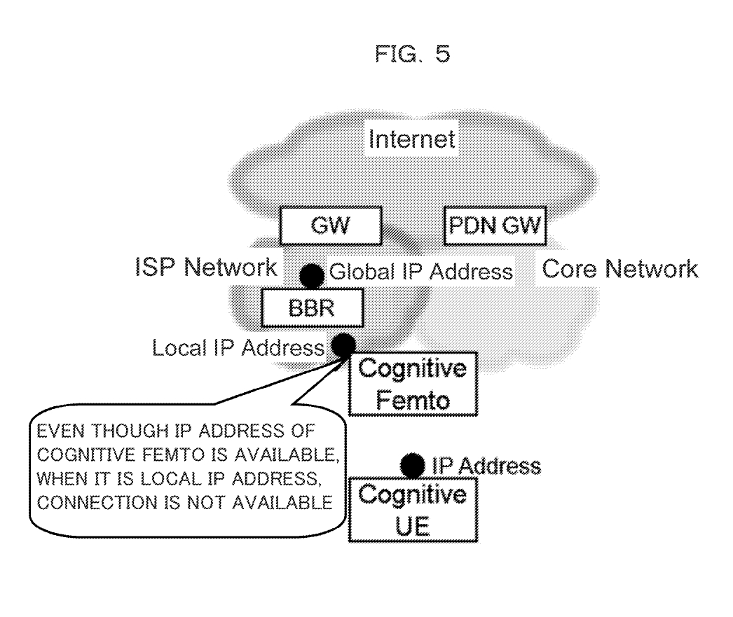

However, it is considered that there is a sufficient possibility that the cognitive femto is installed via a broad band router (BBR) or the like. In this case, the global IP address sent from the ISP is set to the BBR, and the local IP address sent from the BBR is set to the cognitive femto. In this case, even though the cognitive UE recognizes the local IP address allocated to the cognitive femto, since it is unavailable for the cognitive UE to connect to the BBR installed at an upper level of the cognitive femto, it is also unavailable for the cognitive UE to access the cognitive femto (see FIG. 5).

As described above, it is very difficult to universally perform communication between the cognitive femto and the cognitive UE by using their IP addresses each other.

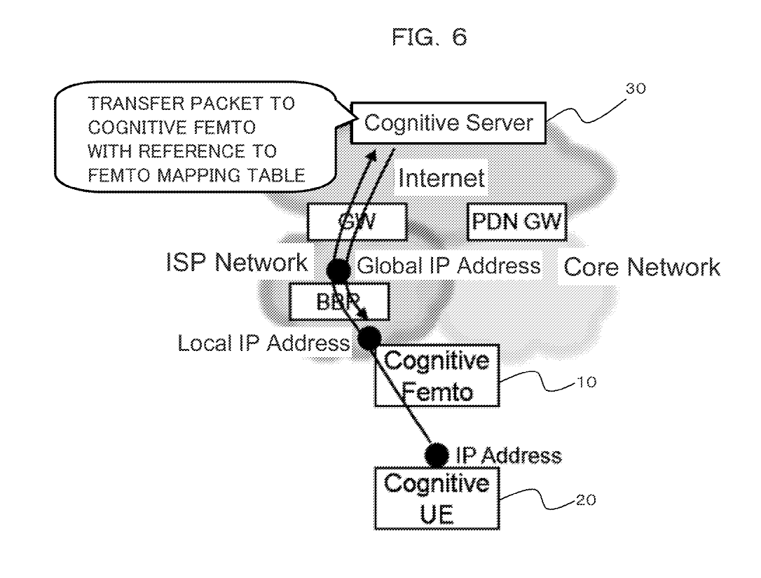

In this regard, in the present embodiment, a communication apparatus (communication relay apparatus) 30 that relays communication between a cognitive femto 10 and a cognitive UE 20 is installed in a network (for example, the Internet) as schematically illustrated in FIGS. 6 to 9.

In other words, communication between the cognitive femto 10 and the cognitive UE 20 is performed indirectly through the communication apparatus 30. Hereinafter, the communication apparatus that relays communication between the cognitive femto 10 and the cognitive UE 20 is referred to as a cognitive server 30.

The cognitive server 30 secures a communication path between the cognitive femto 10 and the cognitive UE 20 regardless of an installation position of the cognitive femto 10, and performs a transferring process of communication data (for example, information related to the radio quality or the like) through the communication path.

The cognitive server 30 is an example of a communication apparatus with the global IP address, which apparatus is installed in the Internet. The communication between the cognitive femto 10 and the cognitive UE 20 is performed by way of the cognitive server 30.

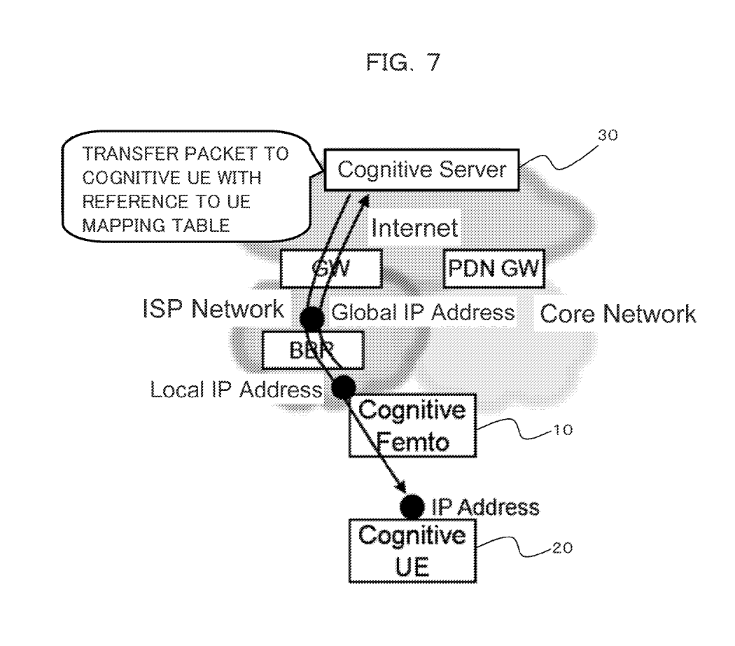

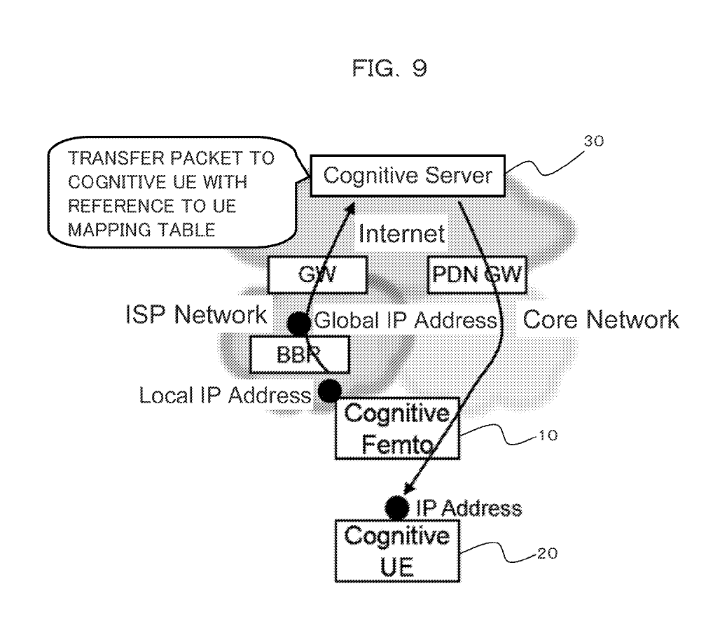

In other words, when the cognitive femto 10 attempts to transmit data to the cognitive UE 20, the cognitive femto 10 does not transmit data directly to the cognitive UE 20. Alternatively, the cognitive femto 10 first transmits data toward the cognitive server 30, and then the cognitive server 30 transfers the received data to the cognitive UE 20 (see FIGS. 7 and 9).

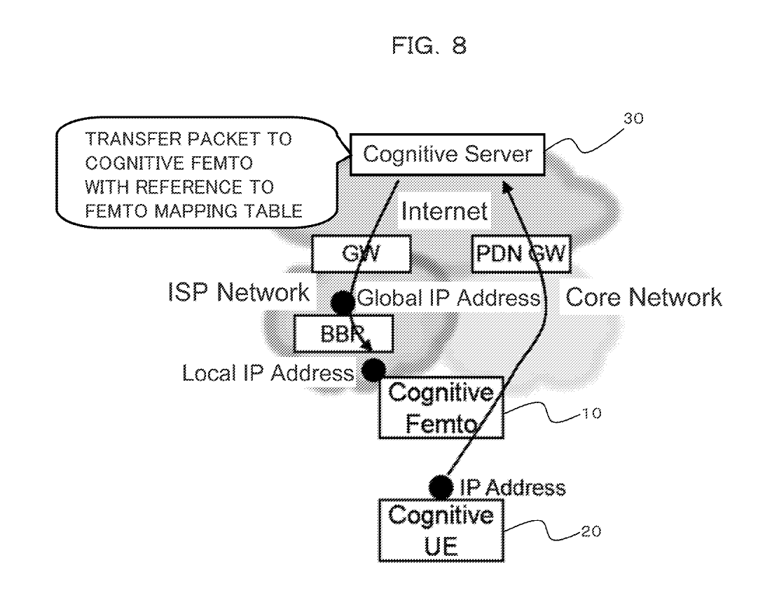

Further, when the cognitive UE 20 attempts to transmit data to the cognitive femto 10, the cognitive UE 20 does not transmit data directly to the cognitive femto 10. Alternatively, the cognitive UE 20 first transmits data toward the cognitive server 30, and then the cognitive server 30 transfers the received data to the cognitive femto 10 (see FIGS. 6 and 8).

FIGS. 6 and 7 illustrate an example in which communication is performed via the BBR when the BBR is installed in the ISP network, and FIGS. 8 and 9 illustrate an example in which communication is performed via the PDW GW when the BBR is installed in the ISP network. The cognitive UE 20 does not need to recognize a route through which communication is performed.

The cognitive server 30 determine a transfer destination with reference to a mapping table held therein in order to transfer data sent from the cognitive femto 10 to the cognitive UE 20 and transfer data sent from the cognitive UE 20 to the cognitive femto 10.

(Generation of Mapping Table of Cognitive Server)

When the cognitive femto 10 is activated, the cognitive femto 10 notifies the cognitive server 30 that the cognitive femto 10 operates as “the cognitive femto 10”. For this, the cognitive femto 10 generates and transmits a cognitive femto registration request to the cognitive server 30.

The cognitive femto registration request may include a cell global identity (CGI) which is defined as an unique identifier of a radio base station by the 3GPP as an identifier of the cognitive femto as exemplified in the following Table 1:

TABLE 1
Cognitive Femto registration request

| No. | Parameter Name | Description |
|---|---|---|
| 1 | Cognitive Femto CGI | Identifier of Femto |

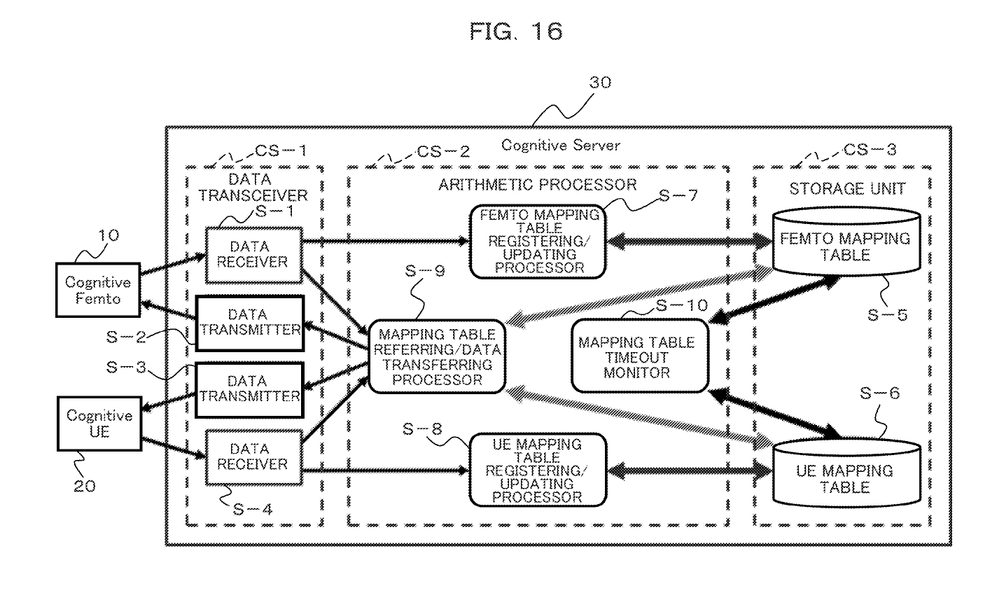

FIG. 16 is a functional block diagram illustrating the cognitive server 30. For example, the cognitive server 30 illustrated in FIG. 16 includes a data transceiver CS-1, an arithmetic processor CS-2, and a storage unit CS-3.

The data transceiver CS-1 includes a data receiver S-1, a data transmitter S-2, a data transmitter S-3, and a data receiver S-4. The functions of the data receiver S-1, the data transmitters S-2 and S-3, and the data receiver S-4 may be implemented by using a gateway central processing unit (GWCPU), a network interface card (NIC), or the like.

The storage unit CS-3 stores a femto mapping table S-5 and a UE mapping table S-6. For example, various kinds of memories known to a person skilled in the art such as a hard disk device (HDD), a random access memory (RAM), or a flash memory may be used as the storage unit CS-3.

The arithmetic processor CS-2 includes functions of a femto mapping table registering/updating processor S-7, a UE mapping table registering/updating processor S-8, a mapping table referring/data transferring processor S-9, and a mapping table timeout monitor S-10. For example, a processor such as a CPU or a digital signal processor (DSP) having an arithmetic capacity may be used as the arithmetic processor CS-2.

Upon receiving the cognitive femto registration request, the cognitive server 30 performs the following operation.

Upon receiving the cognitive femto registration request, the data receiver S-1 notifies the femto mapping table registering/updating processor S-7 of the reception of the cognitive femto registration request.

The femto mapping table registering/updating processor S-7 registers a record including elements such as a source IP address and a source port of a packet of the cognitive femto registration request and a CGI of a transmission source cognitive femto included in the cognitive femto registration request to the femto mapping table S-5 as exemplified in the following Table 2.

TABLE 2
Femto mapping table

| | Femto | Femto | Femnto | Last |
|---|---|---|---|---|
| No. | CGI | Address | Port | Access Time |
| 1 | | | | |
| 2 | | | | |
| . . . | | | | |

Referring to Table 2, the source IP address and the source port of the packet of the cognitive femto registration request are registered as the femto address and the femto port, respectively. Further, a registration time is described as a last access time.

The information of the source IP address and the source port is information of the transmission source communication apparatus that has transmitted the cognitive femto registration request toward the cognitive femto 10. Thus, when the cognitive femto 10 is the transmission source communication apparatus, the source IP address and the source port are information of the cognitive femto 10. However, when any other communication apparatus such as the GW is the transmission source communication apparatus, the source IP address and the source port are information of the corresponding other communication apparatus.

The femto mapping table registering/updating processor S-7 is an example of a base station mapping table manager that manages the femto mapping table S-5 in which identification information of the cognitive femto 10 is associated with information related to a transmission source of the cognitive femto registration request (base station registration request information) transmitted by the cognitive femto 10.

Meanwhile, the cognitive UE 20 notifies the cognitive server 30 that the cognitive UE 20 operates as the “cognitive UE 20” when the cognitive UE 20 enters the area of the cognitive femto 10. For this, the cognitive UE 20 transmits a cognitive UE registration request toward the cognitive server 30.

The cognitive UE registration request may include an international mobile subscriber identity (IMSI) which is defined as an unique identifier for a mobile communication terminal by the 3GPP as an identifier of the cognitive UE 20 as exemplified in the following Table 3.

TABLE 3
Cognitive UE registration request

| No. | Parameter Name | Description |
|---|---|---|
| 1 | Cognitive UE IMSI | Identifier of UE |

Upon receiving the cognitive UE registration request, the cognitive server 30 performs the following operation.

Upon receiving the cognitive UE registration request, the data receiver S-4 (see FIG. 16) notifies the UE mapping table registering/updating processor S-8 of the reception of the cognitive UE registration request.

The UE mapping table registering/updating processor S-8 registers a record including elements such as a source IP address and a source port of a packet of the cognitive UE registration request and an IMSI of a transmission source cognitive UE 20 included in the cognitive UE registration request to the UE mapping table S-6 as exemplified in the following Table 4. A registration time is described as a last access time.

TABLE 4
UE mapping table

| | UE | UE | UE | Last |
|---|---|---|---|---|
| No. | IMSI | Address | Port | Access Time |
| 1 | | | | |
| 2 | | | | |
| . . . | | | | |

The UE mapping table registering/updating processor S-8 is an example of a mobile communication terminal mapping table manager that manages the UE mapping table S-6 in which identification information of the cognitive UE 20 is associated with information related to a transmission source of the cognitive UE registration request (terminal registration request information) transmitted by the cognitive UE 20.

(Relay Process of Cognitive Server 30)

(When Cognitive Server 30 Receives Packet from Cognitive Femto 10)

Upon receiving a packet from the cognitive femto 10, the data receiver S-1 (see FIG. 16) notifies the mapping table referring/data transferring processor S-9 of the reception of the packet.

The mapping table referring/data transferring processor S-9 obtains an IP address and a port number used to transmit the packet to an actual transmission destination UE 20 from the cognitive UE IMSI included in the packet received from the cognitive femto 10 with reference to the UE mapping table S-6.

The mapping table referring/data transferring processor S-9 notifies the data transmitter S-3 of the obtained IP address and port number.

The data transmitter S-3 transmits the packet using the notified IP address and port number as the destination.

The mapping table referring/data transferring processor S-9 overwrites the last access time of the record of the femto mapping table S-5 having the same CGI as a transmission source cognitive femto CGI designated in the received packet with a corresponding time point.

Further, the mapping table referring/data transferring processor S-9 overwrites the last access time of the record of the UE mapping table S-6 having the same IMSI as the destination cognitive UE IMSI designated in the received packet with a corresponding time point.

Note that the femto mapping table S-5 includes the record having the same CGI as that of the transmission source cognitive femto 10 described in the received packet, but a source IP address and a source port of the packet may be different from values of the record of the femto mapping table S-5. In this case, the mapping table referring/data transferring processor S-9 changes (updates) the source IP address and the source port of the record of the femto mapping table S-5 to those of the received packet.

(When Cognitive Server 30 Receives Packet from Cognitive UE 20)

Upon receiving a packet from the cognitive UE 20, the data receiver S-4 (see FIG. 16) notifies the mapping table referring/data transferring processor S-9 of the reception of the packet.

The mapping table referring/data transferring processor S-9 obtains an IP address and a port number used to transmit the packet to an actual transmission destination femto 10 from the cognitive femto CGI included in the packet received from the cognitive UE 20 with reference to the femto mapping table S-5.

The mapping table referring/data transferring processor S-9 notifies the data transmitter S-2 of the obtained IP address and port number.

The data transmitter S-2 transmits the packet using the notified IP address and port number as the transfer destination.

As described above, the data transceiver CS-1, the femto mapping table registering/updating processor S-7, and the mapping table referring/data transferring processor S-9 are an example of a transferring processor. The transferring processor establishes a communication path between the cognitive UE 20 and the cognitive femto 10 based on the respective mapping tables S-5 and S-6 and performs a transferring process of communication data between the cognitive UE 20 and the cognitive femto 10 through the communication path.

The mapping table referring/data transferring processor S-9 overwrites the last access time of the record of the UE mapping table S-6 having the same IMSI as the transmission source cognitive UE IMSI designated in the received packet with a corresponding time point.

Further, the mapping table referring/data transferring processor S-9 overwrites the last access time of the record of the femto mapping table S-5 having the same CGI as a destination cognitive femto CGI designated in the received packet with a corresponding time point.

Note that the UE mapping table S-6 includes the record having the same IMSI as that of a transmission source cognitive UE 20 described in the received packet, but a source IP address and a source port of the packet may be different from values of the record of the UE mapping table S-6. In this case, the mapping table referring/data transferring processor S-9 changes (updates) the source IP address and the source port of the record of the UE mapping table S-6 to those of the received packet.

The cognitive server may perform the following operation in order to detect the cognitive femto 10 or the cognitive UE 20 whose operation is stopped.

For example, the mapping table timeout monitor S-10 (see FIG. 16) scans the femto mapping table S-5, and deletes a record which has not been updated during a certain period of time based on the last access time.

Further, the mapping table timeout monitor S-10 scans the UE mapping table S-6, and deletes a record which has not been updated during a certain period of time based on the last access time.

(Algorithm of Determining Communication Scheme)

The cognitive femto 10 determines a communication (access) scheme to be used by the cognitive UE 20 based on radio environment information collected from the cognitive UE 20, a surrounding radio environment, a communication congestion status, the maximum number of accessible mobile communication terminals, an access ratio load coefficient, or the like. The cognitive femto 10 notifies the cognitive UE 20 of the determined communication scheme. In other words, the cognitive femto 10 implements a process (algorithm) of switching a communication scheme based on the radio quality of the cognitive UE and the communication load of the cognitive femto 10.

An algorithm of determining a communication scheme to be used by the cognitive UE may be divided into the following processes:
the cognitive UE 20 registers its position to the cognitive femto 10;
the cognitive UE 20 that has registered its position notifies the cognitive femto 10 of the radio quality; and
the cognitive femto 10 selects a communication scheme to be used by the cognitive UE 20 based on the notified information.

(Cognitive UE Registration Process)

The cognitive femto 10 manages the cognitive UE 20 positioned in the communication area of the cognitive femto 10 by using a management table exemplified by the following Table 5.

TABLE 5
Management table

| No. | Parameter Name | | Description |
|---|---|---|---|
| 1 | Cognitive UE IMSI | | IMSI of Cognitive UE |
| 2 | LTE Cell RSRP | | LTE reception intensity |
| | | | (dBm) of Cognitive Femto |
| 3 | WiFi AP | SSID | ID of WiFi AP of |
| | | | Cognitive Femto |
| | | RSSI | WiFi reception intensity |
| | | | (dBm) of Cognitive Femto |
| 4 | Neighbor LTE | CGI | ID of neighbor LTE Cell |
| | Cell | RSRP | Reception intensity (dBm) |
| | | | of neighbor LTE |
| 5 | Neighbor | SSID | ID of neighbor WiFi AP |
| | WiFi AP | Channel | Channel of neighbor WiFi |
| | | | AP |
| | | MAC Address | MAC Address of neighbor |
| | | | WiFi AP |
| | | RSSI | Reception intensity (dBm) |
| | | | of neighbor WiFi |
| 6 | Other Radio | ID | Identifier representing |
| | Interference | | other interference source |
| | | RSSI | Intensity of other |
| | | | interference |

| | | |
|---|---|---|
| 7 | Superior Interface Type | Wireless scheme |
| | | instructed to Cognitive |
| | | UE to preferentially use |
| 8 | Active Interface Type | Wireless scheme being |
| | | actually used by |
| | | Cognitive UE |
| 9 | LTE Quality Mark | LTE quality coefficient |
| | | of Cognitive UE |
| | | calculated from |
| | | information above |
| 10 | WiFi Quality Mark | WiFi quality coefficient |
| | | of Cognitive UE |
| | | calculated from |
| | | information above |
| 11 | Last Access Time | Latest update time of |
| | | record |

Meanwhile, the cognitive UE 20 stores information exemplified by the following Table 6 as information of the cognitive UE 20.

TABLE 6
Cognitive UE information

| No. | Parameter Name | | Description |
|---|---|---|---|
| 1 | Cognitive Femto CGI | | CGI of Cognitive Femto in |
| | | | which Cognitive UE is |
| | | | positioned |
| 2 | Cognitive UE IMSI | | IMSI of Cognitive UE |
| 3 | LTE Cell RSRP | | LTE reception intensity |
| | | | (dBm) of Cognitive Femto |
| 4 | WiFi AP | SSID | ID of WiFi AP of |
| | | | Cognitive Femto |
| | | RSSI | WiFi reception intensity |
| | | | (dBm) of Cognitive Femto |
| 5 | Neighbor LTE | CGI | ID of neighbor LTE Cell |
| | Cell | RSRP | Reception intensity (dBm) |
| | | | of neighbor LTE |
| 6 | Neighbor | SSID | ID of neighbor WiFi AP |
| | WiFi AP | Channel | Channel of neighbor WiFi |
| | | | AP |
| | | MAC Address | MAC Address of neighbor |
| | | | WiFi AP |
| | | RSSI | Reception intensity (dBm) |
| | | | of neighbor WiFi |
| 7 | Other Radio | ID | Identifier representing |
| | Interference | | other interference source |
| | | RSSI | Intensity of other |
| | | | interference |

| | | |
|---|---|---|
| 8 | Superior Interface Type | Wireless scheme |
| | | instructed from Cognitive |
| | | Femto to preferentially |
| | | use |
| 9 | Active Interface Type | Wireless scheme being |
| | | actually used by |
| | | Cognitive UE |

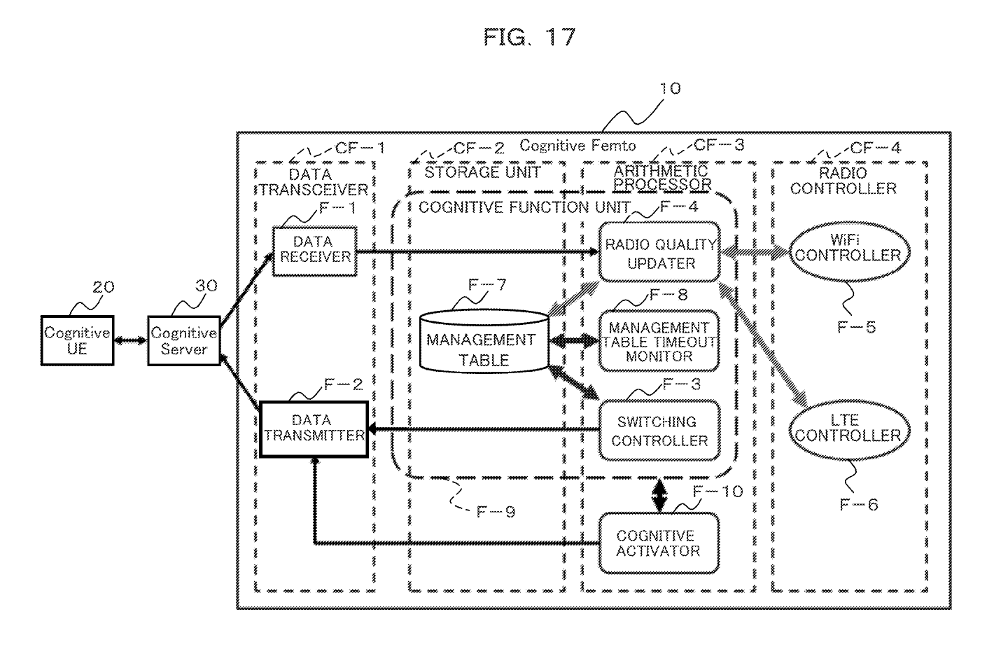

FIG. 17 is a functional block diagram illustrating the cognitive femto 10. For example, the cognitive femto 10 illustrated in FIG. 17 includes a data transceiver CF-1, a storage unit CF-2, an arithmetic processor CF-3, and a radio controller CF-4.

The data transceiver CF-1 includes a data receiver F-1 and a data transmitter F-2. Functions of the data receiver F-1 and the data transmitter F-2 may be implemented using an NIC or the like.

The storage unit CF-2 stores a management table F-7 exemplified by Table 5. Various kinds of memories known to a person skilled in the art such as an HDD, a RAM, or a flash memory may be used as the storage unit CF-2.

The arithmetic processor CF-3 includes functions of a switching controller F-3, a radio quality updater F-4, a management table timeout monitor F-8, and a cognitive activator F-10. A block including the management table F-7, the switching controller F-3, the radio quality updater F-4, and the management table timeout monitor F-8 forms an example of a cognitive function unit (application) F-9. A processor such as a CPU or a DSP having an arithmetic capacity may be used as the arithmetic processor CF-3.

For example, the radio controller CF-4 includes a WiFi controller F-5 that controls the WiFi communication and an LTE controller F-6 that controls the LTE communication. The radio controller CF-4 may be implemented by using a system-on-a-chip (SoC), a DSP, or the like.

The cognitive femto 10 operates as follows when activated.

When the cognitive femto 10 is activated, the cognitive activator F-10 enables the cognitive function unit F-9.

The cognitive activator F-10 transmits the cognitive femto registration request (see Table 1) to the cognitive server 30 through the data transmitter F-2. The data transmitter F-2 is an example of a terminal registration request transmitter that transmits a terminal registration request.

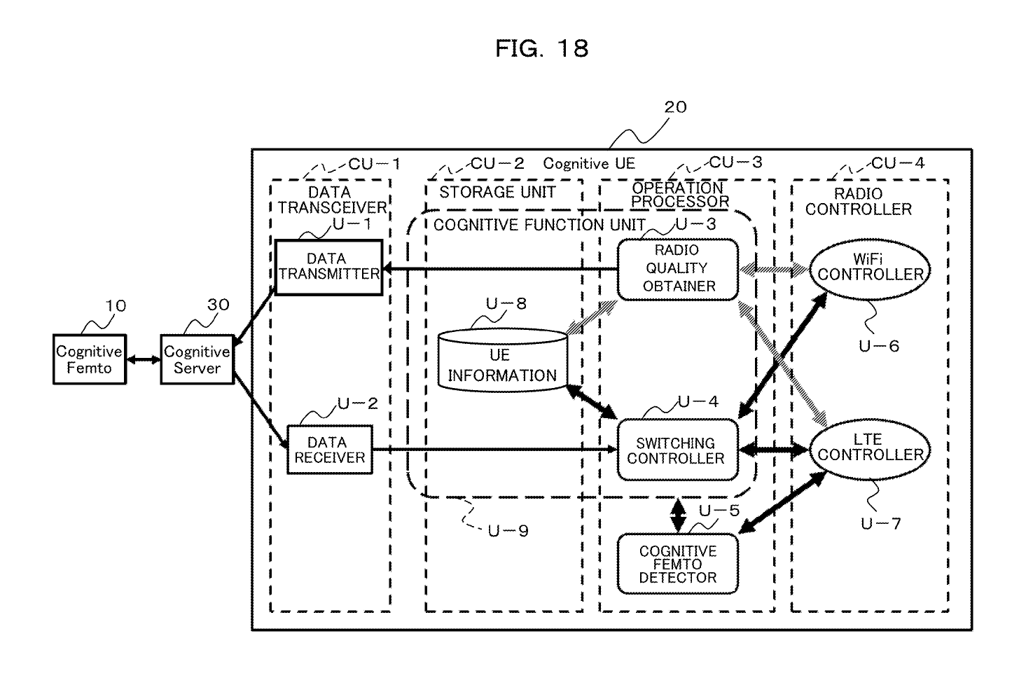

Meanwhile, FIG. 18 is a functional block diagram illustrating the cognitive UE 20. For example, the cognitive UE 20 illustrated in FIG. 18 includes a data transceiver CU-1, a storage unit CU-2, an arithmetic processor CU-3, and a radio controller CU-4.

The data transceiver CU-1 includes a data transmitter U-1 and a data receiver U-2. Functions of the data transmitter U-1 and the data receiver U-2 may be implemented by using an NIC or the like.

The storage unit CU-2 stores UE information (table) U-8 exemplified by Table 6. Various kinds of memories known to a person skilled in the art such as a HDD, a RAM, or a flash memory may be used as the storage unit CU-2.

The arithmetic processor CU-3 includes functions of a radio quality obtainer U-3, a switching controller U-4, and a cognitive femto detector U-5. A block including the UE information U-8, the radio quality obtainer U-3, and the switching controller U-4 forms an example of a cognitive function unit (application) U-9. A processor such as a CPU or a DSP having an arithmetic capacity may be used as the arithmetic processor CU-3.

The radio controller CU-4 includes, for example, a WiFi controller U-6 that controls the WiFi communication and an LTE controller U-7 that controls the LTE communication. The radio controller CU-4 may be implemented by using a SoC, a DSP, or the like.

The cognitive UE 20 operates as follows when the cognitive UE 20 enters the area of the cognitive femto 10.

First of all, the cognitive femto detector U-5 of the cognitive UE 20 enables the cognitive function unit U-9, when a cell into which the cognitive UE 20 has entered is determined as a cell provided by the cognitive femto 10 based on information (cell identification information such as a CGI, a tracking area code, a physical cell identity, or a closed subscriber group) obtained from the LTE controller U-7.

The radio quality obtainer U-3 of the cognitive function unit U-9 collects surrounding radio information through the WiFi controller U-6 and the LTE controller U-7 and generates the UE information U-8 exemplified by Table 6. The generated UE information U-8 is stored in the storage unit CU-2 through the radio quality obtainer U-3.

The radio quality obtainer U-3 includes the same information as the UE information U-8 in the cognitive UE registration request (see Table 3) and notifies the cognitive femto 10 of the request through the data transmitter U-1.

Upon receiving the cognitive UE registration request through the data receiver F-1, the cognitive femto 10 (see FIG. 17) notifies the radio quality updater F-4 of the reception of the cognitive UE registration request.

The radio quality updater F-4 refers to the management table F-7 (see Table 5) using the IMSI included in the cognitive UE registration request as a key. When the IMSI of the cognitive UE 20 that has transmitted the cognitive UE registration request is not present in the management table F-7 (see Table 5), the radio quality updater F-4 registers a new record to the management table F-7 based on the content of the cognitive UE registration request. At this time, the radio quality updater F-4 calculates an LTE quality mark and a WiFi quality mark using the same method as “a radio quality update process” which will be described later. Further, a reception time is used as the last access time.

The radio quality updater F-4 is an example of a registering processor that registers the UE registration request to the management table F-7 when the UE registration request transmitted by the cognitive UE 20 is received from the cognitive server 30 through the communication path established by the cognitive server 30.

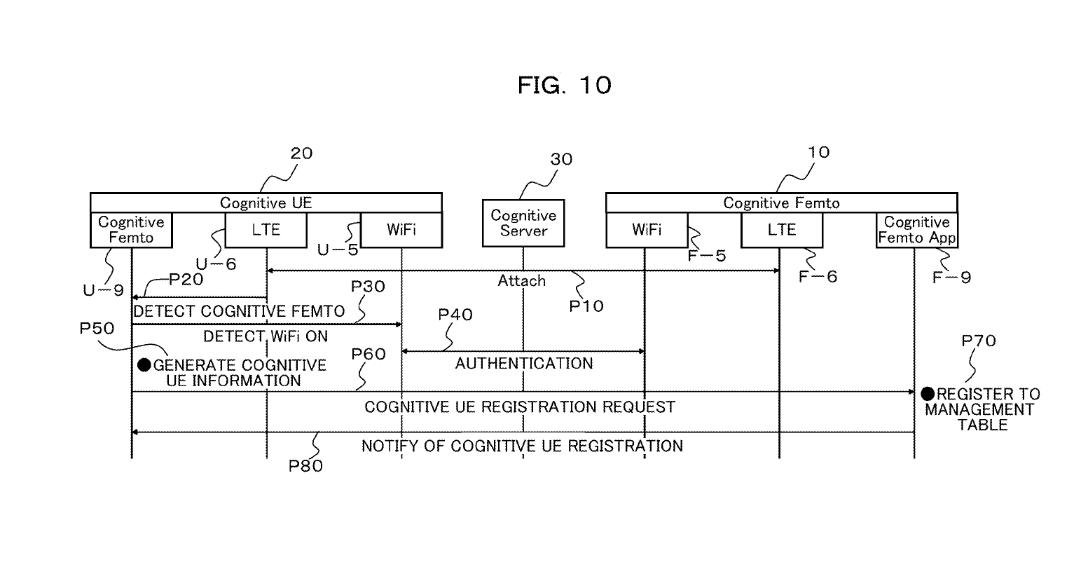

FIG. 10 illustrates an exemplary cognitive UE registration sequence.

As illustrated in FIG. 10, the cognitive UE 20 performs an attach process with the cognitive femto 10 when power is turned on (process P10).

The attach process is a sequence of registering the cognitive UE 20 to a network (the cognitive femto 10). The attach process is performed by the LTE controller U-6 of the cognitive UE 20 and the LTE controller F-6 of the cognitive femto 10.

After the attach process, the cognitive UE 20 enables the cognitive function unit U-9 when the cognitive femto detector U-5 determines that the cell into which the cognitive UE 20 has entered is the cell provided by the cognitive femto 10 as mentioned before (process P20).

The cognitive function unit U-9 transmits an ON request to the WiFi controller U-6 to enable the WiFi communication (process P30). The WiFi controller U-6 performs a predetermined authentication process with the WiFi controller F-5 of the cognitive femto 10 and establishes a WiFi connection with the cognitive femto 10 (process P40).

As a result, the cognitive UE 20 is able to collect surrounding radio information through the WiFi controller U-6 and the LTE controller U-7 by using the radio quality obtainer U-3.

Then, the radio quality obtainer U-3 generates the UE information U-8 (process P50), includes the UE information U-8 in the cognitive UE registration request (see Table 3), and notifies the cognitive femto 10 of the resultant cognitive UE registration request through the data transmitter U-1 (process P60).

Upon receiving the cognitive UE registration request through the data receiver F-1, the cognitive femto 10 registers a record to the management table F-7 based on the content of the cognitive UE registration request by using the radio quality updater F-4 as mentioned before (process P70).

When the registration of the record to the management table F-7 is completed, the cognitive femto 10 may transmit information (cognitive UE registration notification) representing that the registration has been completed to the cognitive UE 20 through the data transmitter F-2 (process P80).

The cognitive femto 10 may scan the management table F-7 by the management table timeout monitor F-8 and delete the record that has not been updated during a certain period of time based on the last access time. Thus, it is possible to prevent the number of records in the management table F-7 (see FIG. 17 and Table 5) from increasing unlimitedly.

Further, when the cognitive UE 20 goes out of the area of the cognitive femto, the cognitive UE 20 operates as follows. For example, the cognitive femto detector U-5 (see FIG. 18) of the cognitive UE 20 disables the cognitive function unit U-9 when it is determined that the cognitive UE 20 has gone out of the area of the cognitive femto 10 based on information (the cell identification information such as the CGI, the tracking area code, the physical cell identity, or the closed subscriber group) obtained from the LTE controller U-7.

(Radio Quality Update Process)

The cognitive UE 20 operates as follows when a change in the surrounding radio quality is detected. For example, when a change in the radio quality is detected by the WiFi controller U-6 and the LTE controller U-7, the radio quality obtainer U-3 updates the UE information U-8 based on the changed radio quality information.

Further, when the quality of Bluetooth (which is a registered trademark) is considered as the surrounding radio quality, the radio quality obtainer U-3 may detect the change in the radio quality through a Bluetooth controller (not illustrated). The Bluetooth controller may be equipped as a function of the radio controller CU-4 illustrated in FIG. 18.

The radio quality obtainer U-3 transmits information other than a superior interface type and an active interface type of the updated UE information U-8 to the cognitive femto 10 through the data transmitter U-1 as radio quality change request information exemplified by the following Table 7. The data transmitter U-1 is an example of a radio quality transmitter that transmits information related to the obtained radio quality to the cognitive femto 10.

TABLE 7
Radio quality change request information

| No. | Parameter Name | | Description |
|---|---|---|---|
| 1 | Cognitive Femto CGI | | CGI of destination |
| | | | Cognitive Femto |
| 2 | Cognitive UE IMSI | | IMSI of transmission |
| | | | source Cognitive UE |
| 3 | LTE Cell RSRP | | LTE reception intensity |
| | | | (dBm) of Cognitive Femto |
| 4 | WiFi AP | SSID | ID of WiFi AP of |
| | | | Cognitive Femto |
| | | RSSI | WiFi reception intensity |
| | | | (dBm) of Cognitive Femto |
| 5 | Neighbor LTE | CGI | ID of neighbor LTE Cell |
| | Cell | RSRP | Reception intensity (dBm) |
| | | | of neighbor LTE |
| 6 | Neighbor | SSID | ID of neighbor WiFi AP |
| | WiFi AP | Channel | Channel of neighbor WiFi |
| | | | AP |
| | | MAC Address | MAC Address of neighbor |
| | | | WiFi AP |
| | | RSSI | Reception intensity (dBm) |
| | | | of neighbor WiFi |
| 7 | Other Radio | ID | Identifier representing |
| | Interference | | other interference source |
| | | RSSI | Intensity of other |
| | | | interference |

The cognitive femto 10 (see FIG. 17) that has received the radio quality change request information from the cognitive UE 20 operates as follows. For example, the radio quality updater F-4 that has received the radio quality change request information through the data receiver F-1 updates the record of the management table F-7 having the same IMSI as the IMSI included in the received radio quality change request information with the content of the received radio quality change request information. The LTE quality mark and the WiFi quality mark are calculated based on the received radio quality change request information, and a reception time is used as the last access time.

As a non-limited example, the LTE quality mark may be a value obtained by subtracting a value, which is obtained by converting RSRPs (dBm) of neighboring LTE cells into power values (mW), adding the power values, and converting the added power value into a value of dBm, from RSRP (dBm) of the LTE of the cognitive femto 10.

Further, for example, when Bluetooth is considered as other Radio Interference, the following value may be used as the WiFi quality mark. As a non-limited example, the WiFi quality mark may be a value obtained by subtracting a value, which is obtained by converting RSSIs (dBm) of a neighboring WiFi access point (AP) and a neighboring Bluetooth into power values (mW), multiplying the power values by a load (weight) according to a neighboring WiFi channel, adding the resultant power values, and converting the power value into a value of dBm, from RSSI (dBm) of the WiFi of the cognitive femto 10.

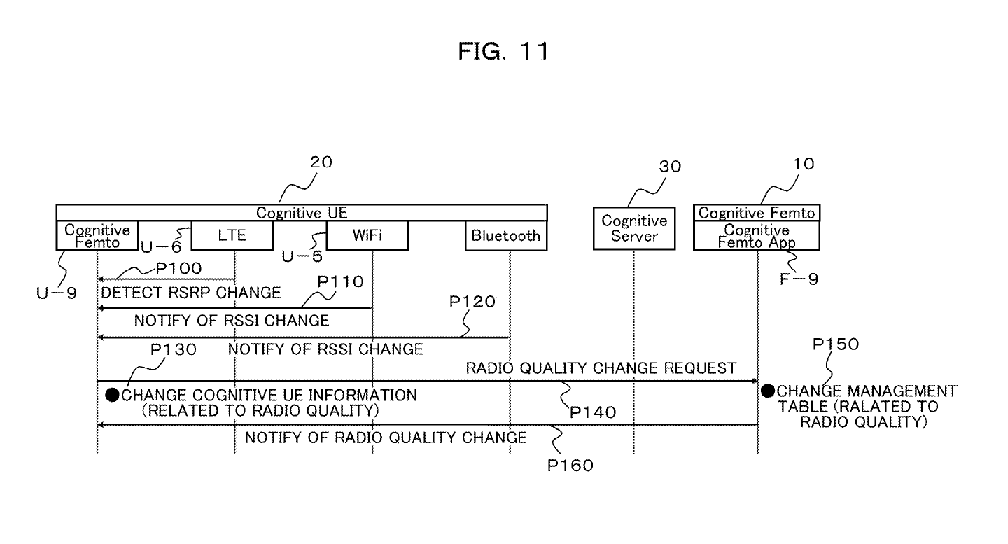

FIG. 11 illustrates an exemplary radio quality update process (sequence).

The cognitive function unit U-9 of the cognitive UE 20 receives notification indicating a change in the radio quality from any one of the LTE controller U-7, the WiFi controller U-6, and the Bluetooth controller (not illustrated) (processes P100 to P120).

Then, the cognitive function unit U-9 updates the UE information U-8 based on the notified information by the radio quality obtainer U-3 (process P130). Further, the radio quality obtainer U-3 transmits information other than the superior interface type and the active interface type of the updated UE information U-8 to the cognitive femto 10 as the radio quality change request information exemplified by Table 7 as mentioned before (process P140).

The cognitive femto 10 updates the record of the management table F-7 having the same IMSI as the IMSI included in the received radio quality change request information with the content of the received radio quality change request information as mentioned before (process P150). When the update is completed, the cognitive femto 10 may transmit information (radio quality change notification) indicating the completion of the update to the cognitive UE 20.

(Switching Control Process)

The cognitive femto 10 calculates an ideal ratio (load balancing rate) of the LTE communication, the number of UEs having accessed to the LTE communication and the number of UEs having accessed to the WiFi communication based on the following information (a) to (d). Then, the cognitive femto 10 determines a priority access scheme of the cognitive UE 20 based on the LTE quality mark and the WiFi quality mark so that an actual LTE/WiFi access ratio gets close to the load balancing rate (target ratio).

(a) an interference value of LTE/WiFi being received by the cognitive femto 10

(b) a resource utilization rate of LTE/WiFi of the cognitive femto 10

(c) a maximum value of the number of accessible UEs of LTE/WiFi of the cognitive femto 10

(d) a load of a ratio of UEs having accessed to the LTE and UEs having accessed to the WiFi, which ratio is set to the cognitive femto 10

The cognitive femto 10 (see FIG. 17) calculates the load balancing rate as follows.

First, the switching controller F-3 obtains a resource utilization rate and the maximum value of the number of accessible UEs of LTE/WiFi from the WiFi controller F-5 and the LTE controller F-6.

Further, the switching controller F-3 obtains an interference value of LTE/WiFi being received by the cognitive femto 10 from the WiFi controller F-5 and the LTE controller F-6. Alternatively, the switching controller F-3 may estimate the interference value of LTE/WiFi being received by the cognitive femto 10 based on information of the respective cognitive UEs 20 of the management table F-7.

When there is a load coefficient of an access number of LTE/WiFi, the switching controller F-3 obtains the value from the storage unit CF-2.

Then, the switching controller F-3 calculates the load balancing rate based on the obtained information. The cognitive femto 10 stores switching determination parameters exemplified by the following Table 8 in the storage unit CF-2 in order to perform a switching process.

TABLE 8
Switching determination parameters

| No. | Parameter Name | Description |
|---|---|---|
| 1 | MaxLTEUENum | Maximum value of number of UEs |
| | | accessible with LTE |
| 2 | MaxWiFiUENum | Maximum value of number of UEs |
| | | accessible with WiFi |
| 3 | LTEUtilization | LTE utilization rate of cell |
| 4 | WiFiUtilization | WiFi utilization rate of cell |
| 5 | LTECellInterference | Total LTE interference of cell |
| 6 | WiFiCellInterference | Total WiFi interference of |
| | | cell |
| 7 | OffloadRate | Requirement of LTE/WiFi ratio |
| 8 | LoadBalancingRate | Index of ratio of LTE:WiFi |
| | | of Cognitive UE |

The LTE utilization represents a utilization rate of LTE and corresponds to a utilization rate of resource blocks (RBs). The WiFi utilization represents a utilization rate of the WiFi and corresponds to a total throughput utilization rate.

The cognitive femto 10 that has calculated the load balancing rate determines the access scheme of each cognitive UE 20 as follows.

For example, the switching controller F-3 obtains the number of UEs having accessed to the LTE and the number of UEs having accesses to the WiFi among all UEs (which may include a general UE other than the cognitive UE 20) from the WiFi controller F-5 and the LTE controller F-6.

The switching controller F-3 obtains a current access scheme of each cognitive UE 20 from the management table F-7.

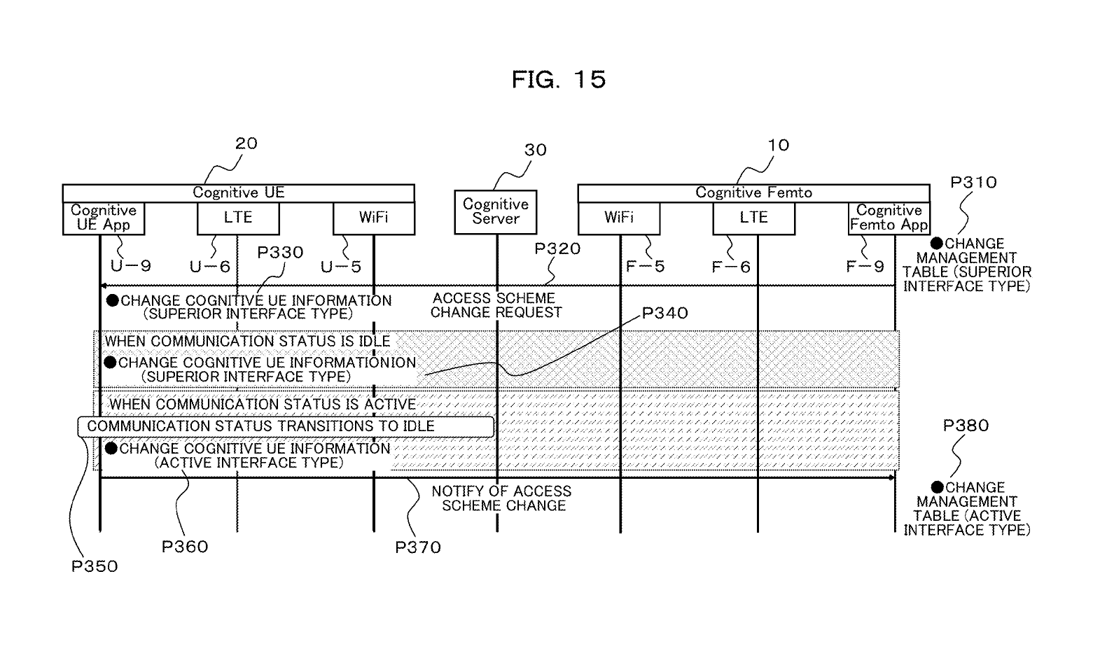

The switching controller F-3 changes the superior interface type of each cognitive UE 10 so that the ratio of the number of UEs having accessed to the LTE and the number of UEs having accessed to the WiFi among all UEs (which may include a general UE other than the cognitive UE 10) gets close to the load balancing rate (process P310 in FIG. 15). This change is performed based on the LTE quality mark and the WiFi quality mark of each cognitive UE10.

The switching controller F-3 transmits an access scheme change request exemplified by the following Table 9 to each cognitive UE10 that has changed the superior interface type through the data transmitter F-2 (process P320 in FIG. 15).

TABLE 9
Access scheme change request

| No. | Parameter Name | Description |
|---|---|---|
| 1 | Cognitive Femto | CGI of transmission source |
| | CGI | Cognitive Femto |
| 2 | Cognitive UE IMSI | IMSI of destination Cognitive UE |
| 3 | Superior Interface | Wireless scheme instructed to |
| | Type | Cognitive UE to preferentially |
| | | use |

The switching controller F-3 is an example of a controller that controls a communication scheme of the cognitive UE 20 based on information related to the radio quality around the cognitive UE 20 and information related to a communication load of the cognitive femto 20 when the information related to the radio quality around the cognitive UE 20 obtained in the cognitive UE 20 serving as the transmission source of the UE registration request information registered to the management table F-7 is received from the cognitive server 30 through a communication path established by the cognitive server 30.

Upon receiving the access scheme change request from the cognitive femto 10, the cognitive UE 20 (see FIG. 18) operates as follows.

First, the switching controller U-4 changes the superior interface type of the UE information U-8 (see Table 6) based on the access scheme change request received through the data receiver U-2 (process P330 in FIG. 15).

The switching controller U-4 gives a notification for enabling a scheme designated by the superior interface type to the WiFi controller U-6 and the LTE controller U-7.

When the access scheme is switched to the scheme designated by the superior interface type, the switching controller U-4 reflects a scheme switched to the active interface type of the UE information U-8 (processes P340 and P360 in FIG. 15). This reflecting may be performed during a communication status is an idle status. When a communication status is an active status, the reflecting may be performed after the communication status transitions to the idle status (status transition P350 in FIG. 15).

When the access scheme is switched, the switching controller U-4 transmits information (access scheme change notification) indicating that the access scheme has been switched to the cognitive femto 10 (process P370 in FIG. 15). Upon receiving the access scheme change notification, the cognitive femto 10 (the cognitive function unit F-9: see FIG. 17) changes the active interface type of the management table F-7 (see Table 5) to the notified access scheme (process P380 in FIG. 15).

An exemplary algorithm of selecting a cognitive UE 20 which is subject to changing the superior interface type based on the load balancing rate, the LTE quality mark, and the WiFi quality mark will be described below.

(When Ratio of UEs Having Accessed to LTE is Larger than Load Balancing Rate by Predetermined Value or More)

For the cognitive UEs 20 having accessed to the LTE, the LTE quality mark is compared with WiFi quality mark starting from the cognitive UE 20 having the small LTE quality mark. When the WiFi quality mark is higher, the superior interface type of the corresponding cognitive UE is changed to the WiFi. This operation is repeated until the ratio of UEs having accessed to the LTE is equal to or less than the load balancing rate or until the number of the cognitive UEs having accessed to the LTE becomes zero (0).

Although all of the cognitive UEs 20 are scanned, when the ratio of UEs having accessed to the LTE is neither equal to nor less than the load balancing rate or when the number of the cognitive UEs having accessed to the LTE is not zero (0), the following operation is performed. For example, the superior interface type is changed to the WiFi starting from the cognitive UE 20 having the small LTE quality mark until the ratio of UEs having accessed to the LTE is equal to or less than the load balancing rate or until the number of the cognitive UEs having accessed to the LTE is zero (0).

Even though the above operation is performed, when the ratio of UEs having accessed to the LTE is neither equal to nor less than the load balancing rate or when the number of the cognitive UEs having accessed to the LTE does not become zero (0), the switching operation is stopped at that time.

(When Ratio of UEs Having Accessed to LTE is Smaller than Load Balancing Rate by Predetermined Value or More)

For the cognitive UEs 20 having accessed to the WiFi, the LTE quality mark is compared with the WiFi quality mark starting from the cognitive UE 20 having the small WiFi quality mark. When the LTE quality mark is higher, the superior interface type of the corresponding cognitive UE is changed to LTE. This operation is repeated until the ratio of UEs having access to LTE is equal to or larger than the load balancing rate or until the number of the cognitive UEs having accessed to the WiFi becomes zero (0).

Although all of the cognitive UEs 20 are scanned, when the ratio of UEs having access to LTE is neither equal to nor larger than the load balancing rate or when the number of the cognitive UEs having accessed to the WiFi does not become zero (0), the following operation is performed. For example, the superior interface type is changed to the LTE starting from the cognitive UE 20 having the small WiFi quality mark until the ratio of UEs having accessed to the LTE is equal to or larger than the load balancing rate or until the number of the cognitive UEs having accessed to the WiFi becomes zero (0).

Even though the above operation is performed, when the ratio of UEs having accessed to the LTE is neither equal to nor larger than the load balancing rate or when the number of the cognitive UEs having accessed to the WiFi does not become zero (0), the switching operation is stopped at that time.

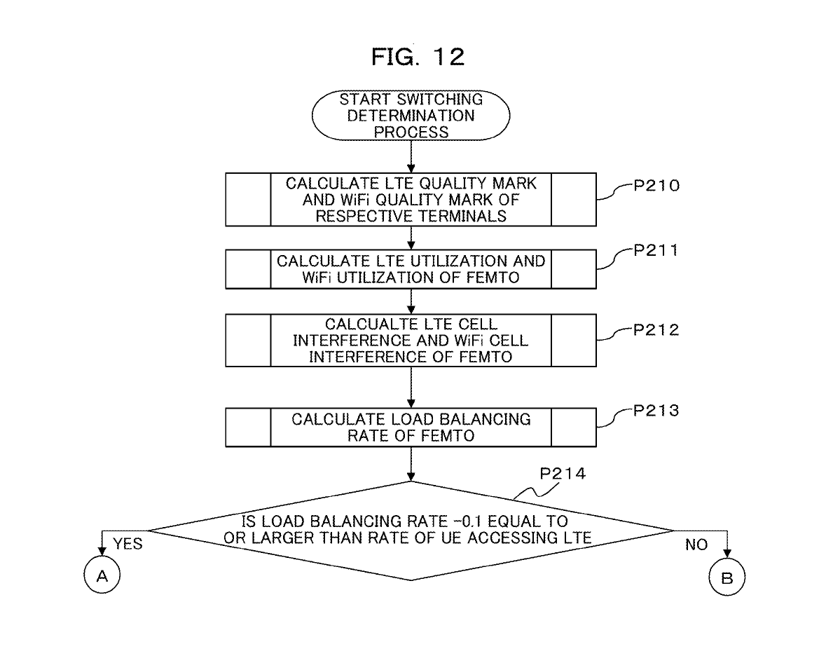

FIGS. 12 to 14 are exemplary flowcharts illustrating the switching determination process.

As illustrated in FIG. 12, the switching controller F-3 of the cognitive femto 10 calculates the LTE quality mark and the WiFi quality mark of each UE 20 (process P210). Further, the switching controller F-3 calculates the LTE utilization and the WiFi utilization of the cognitive femto 10 (process P211).

Furthermore, the switching controller F-3 calculates LTE cell interference and WiFi cell interference of the cognitive femto 10 (process P212). The switching controller F-3 also calculates the load balancing rate of the cognitive femto 10 (process P213). The order of processes P210˜P213 may be changed.

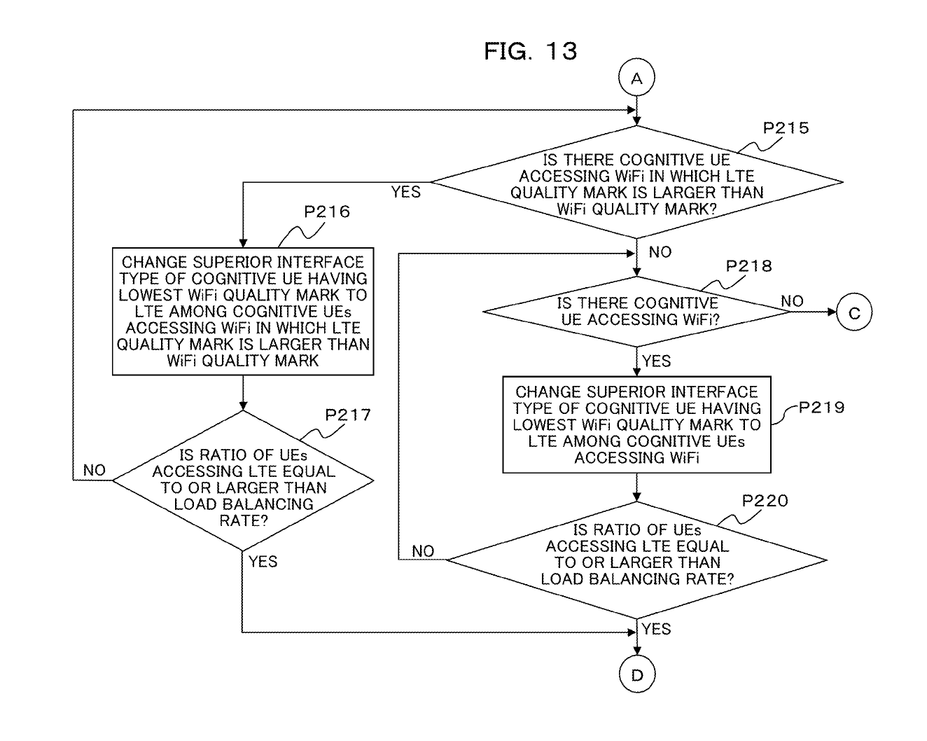

The switching controller F-3 determines whether the load balancing rate−0.1 is equal to or larger than the ratio of UEs 20 having accessed to the LTE (process P214). When the determination result is YES, the switching controller F-3 further determines whether the LTE quality mark is larger than the WiFi quality mark as illustrated in FIG. 13 (process P215).

When the determination result is YES, the switching controller F-3 changes the superior interface type of the cognitive UE 20 having the lowest WiFi quality mark among the cognitive UEs 20 having accessed to the WiFi to the LTE (process P216).

Then, the switching controller F-3 determines whether the load balancing rate is equal to or less than the ratio of UEs 20 having accessed to the LTE (process P217). When the determination result is YES, the switching controller F-3 returns to process P215. When the determination result is NO, the switching controller F-3 ends the switching determination process.

Meanwhile, when the determination result in process P215 is NO, the switching controller F-3 further determines whether there is a cognitive UE 20 having accessed to the WiFi (process P218). When the determination result is NO, the switching controller F-3 ends the switching determination process. When the determination result is YES, the switching controller U-4 further determines whether there is a cognitive UE 20 having accessed to the WiFi (process P218).

When the determination result is NO, the switching controller F-3 ends the switching determination process. When the determination result is YES, the switching controller F-3 changes the superior interface type of the cognitive UE 20 having the lowest WiFi quality mark among the cognitive UEs 20 having accessed to the WiFi and having the LTE quality mark larger than the WiFi quality mark to the LTE (process P219)

Then, the switching controller F-3 further determines whether the load balancing rate is equal to or less than the ratio of UEs 20 having accessed to the LTE (process P220). When the determination result is YES, the switching controller F-3 ends the switching determination process. When the determination result is NO, the switching controller F-3 returns to process P218.

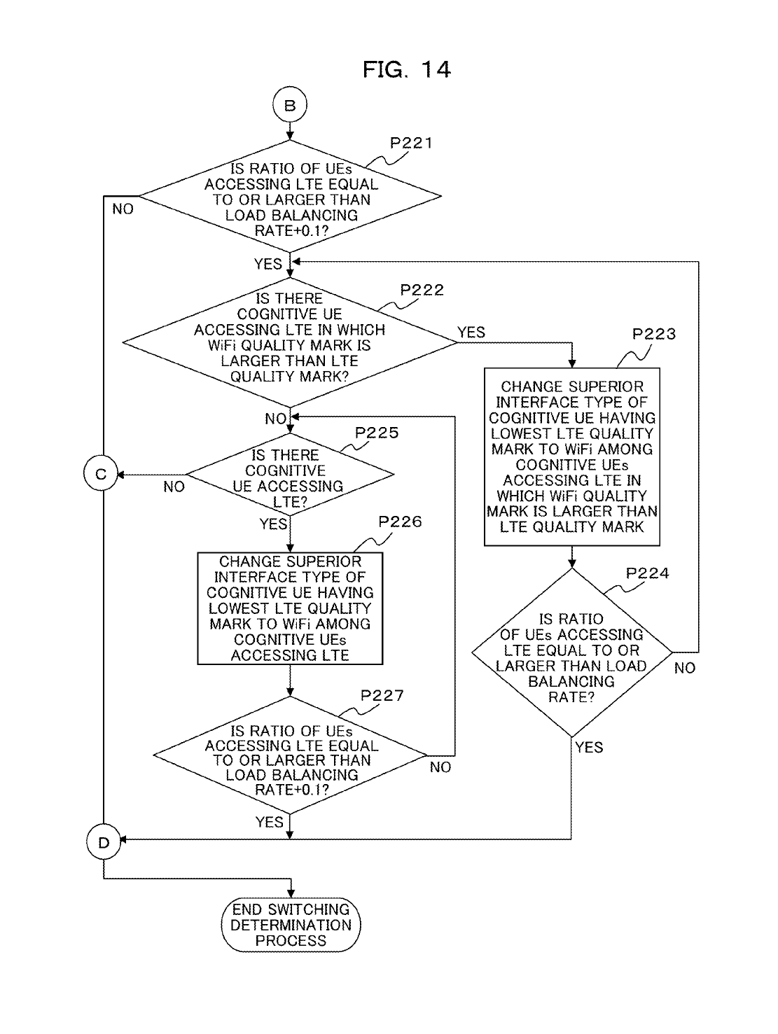

Further, when the determination result in process P214 is NO, the switching controller F-3 determines whether “the load balancing rate+0.1” is equal to or less than the ratio of UEs 20 having accessed to the LTE as illustrated in FIG. 14 (process P221).

When the determination result is NO, the switching controller F-3 ends the switching determination process. When the determination result is YES, the switching controller F-3 further determines whether there is a cognitive UE 20 having accessed to the LTE and having the WiFi quality mark larger than the LTE quality mark (process P222).

When the determination result is YES, the switching controller F-3 changes the superior interface type of the cognitive UE 20 having the lowest LTE quality mark among the cognitive UEs 20 having accessed to the LTE and having the WiFi quality mark larger than the LTE quality mark to the WiFi (process P223).

Then, the switching controller F-3 further determines whether the load balancing rate is equal to or larger than the ratio of UEs 20 having accessed to the LTE (process P224). When the determination result is YES, the switching controller F-3 ends the switching determination process. When the determination result is NO, the switching controller F-3 returns to process P222.

Further, when the determination result in process P222 is NO, the switching controller F-3 determines whether there is a cognitive UE 20 having accessed to the LTE (process P225). When the determination result is NO, the switching controller F-3 ends the switching determination process. When the determination result is YES, the switching controller F-3 changes the superior interface type of the cognitive UE 20 having the lowest LTE quality mark among the cognitive UEs 20 having accessed to the LTE to the WiFi (process P226).

Then, the switching controller F-3 determines whether the load balancing rate is equal to or larger than the ratio of UEs 20 having accessed to the LTE (process P227). When the determination result is YES, the switching controller F-3 ends the switching determination process. When the determination result is NO, the switching controller F-3 returns to process P225.

(Cognitive System Maintaining Process)

The cognitive femto 10 and the cognitive UE 20 perform the following operation in order to maintain the cognitive system.

There is a case that the cognitive femto 10 neither transmits data to the cognitive UE 20 nor receives data from the cognitive UE 20 during a certain period of time or more. In this case, the cognitive activator F-10 (see FIG. 17) of the cognitive femto 10 transmits the cognitive femto registration request to the cognitive server 30 again. By this, the registration of the cognitive femto 10 to the femto mapping table S-5 of the cognitive server 30 is maintained.

Further, there is a case that the cognitive UE 20 neither transmits data to the cognitive femto 10 nor receives data from the cognitive femto 10 during a certain period of time or more. In this case, the radio quality obtainer U-3 of the cognitive UE 20 transmits the radio quality change request to the cognitive femto 10 even though there is no change in the radio quality. By this, it is possible to guarantee that the management of the cognitive UE 20 is maintained by the cognitive femto 10. Further, it is possible to guarantee that the management of the cognitive UE 20 is maintained by the UE mapping table S-6 (see FIG. 16) of the cognitive server 30.

As described all the above, regarding the cognitive femto 10 and the cognitive UE 20 that support a plurality of communication schemes, a communication scheme to be used by the cognitive UE 20 is determined on the initiative of the cognitive femto 10, and thus it is possible to realize high-quality communication.

Further, with a network configuration using the cognitive server 30, communication between the cognitive femto 10 and the cognitive UE 20 can be performed regardless of the installation environment of the cognitive femto 10.

Furthermore, with the “radio quality update process” and the “switching control process,” it is possible to switch the communication schemes based on a radio quality of each cognitive UE 20 and a communication load of the cognitive femto 10.

According to the above-described embodiment, it is possible to establish a communication path between a mobile communication terminal and a radio base station via a communication relay apparatus. Further, the radio base station is capable of controlling, based on the radio quality around the mobile communication terminal, a communication scheme of the mobile communication terminal through the communication path.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A communication relay apparatus, comprising:
a mobile communication terminal mapping table manager configured to manage a terminal mapping table in which identification information of a mobile communication terminal is associated with information related to a transmission source of terminal registration request information transmitted by the mobile communication terminal;
a base station mapping table manager configured to manage a base station mapping table in which identification information of a radio base station is associated with a transmission source of base station registration request information transmitted by the radio base station; and
a transferring processor configured to:
establish a communication path between the mobile communication terminal and the radio base station based on the respective mapping tables; and
perform a transferring process of communication data between the mobile communication terminal and the radio base station through the communication path.

2. The communication relay apparatus according to claim 1, further comprising:
a mapping table timeout monitoring processor configured to monitor the respective mapping tables and delete a record that has not been updated during a certain period of time.

3. A mobile communication terminal configured to: communicate with a radio base station through a communication path established by the communication relay apparatus according to claim 1; and support a plurality of communication schemes, comprising:
a terminal registration request transmitting processor configured to transmit the terminal registration request information;
a radio quality obtaining processor configured to obtain information related to a surrounding radio quality;
a radio quality transmitting processor configured to transmit the obtained information to the radio base station; and
a switching control processor configured to switch the communication scheme according to a communication scheme determined by the radio base station based on the radio quality and information related to a communication load of the radio base station.

4. A mobile communication terminal configured to: communicate with a radio base station through a communication path established by the communication relay apparatus according to claim 2; and support a plurality of communication schemes, comprising:
a terminal registration request transmitting processor configured to transmit the terminal registration request information;
a radio quality obtaining processor configured to obtain information related to a surrounding radio quality;
a radio quality transmitting processor configured to transmit the obtained information to a radio base station; and
a switching control processor configured to switch the communication scheme according to a communication scheme determined by the radio base station based on the radio quality and information related to a communication load of the radio base station.

5. A radio base station configured to: communicate with a mobile communication terminal through a communication path established by the communication relay apparatus according to claim 1; and support a plurality of communication schemes, comprising:
a base station registration request transmitting processor configured to transmit the base station registration request information;
a terminal registration request transmitting processor configured to transmit the terminal registration request information;
a registering processor configured to register the terminal registration request information to a management table upon receiving the terminal registration request information transmitted by the mobile communication terminal from the communication relay apparatus through the communication path; and
a controller configured to control, upon receiving information from the communication relay apparatus through the communication path, a communication scheme of the mobile communication terminal based on the received information related to a radio quality around the mobile communication terminal obtained in the mobile communication terminal which is a transmission source of the terminal registration request information registered to the management table and information related to a communication load of the radio base station.

6. A radio base station configured to: communicate with a mobile communication terminal through a communication path established by the communication relay apparatus according to claim 2; and support a plurality of communication schemes, comprising:
a base station registration request transmitting processor configured to transmit the base station registration request information;
a terminal registration request transmitting processor configured to transmit the terminal registration request information;
a registering processor configured to register the terminal registration request information to a management table upon receiving the terminal registration request information transmitted by the mobile communication terminal from the communication relay apparatus through the communication path; and
a controller configured to control, upon receiving information from the communication relay apparatus through the communication path, a communication scheme of the mobile communication terminal based on the received information related to a radio quality around the mobile communication terminal obtained in the mobile communication terminal which is a transmission source of the terminal registration request information registered to the management table and information related to a communication load of the radio base station.

7. The radio base station according to claim 5,
wherein the controller performs the control such that a ratio of a communication scheme used by a plurality of mobile communication terminals gets close to a target ratio based on information related to the radio quality and information related to the communication load.

8. The radio base station according to claim 6,
wherein the controller performs the control such that a ratio of a communication scheme used by a plurality of mobile communication terminals gets close to a target ratio based on information related to the radio quality and information related to the communication load.

9. The radio base station according to claim 5, further comprising,
a management table timeout monitoring processor configured to monitor the management table and delete a record that has not been updated during a certain period of time.

10. The radio base station according to claim 6, further comprising,
a management table timeout monitoring processor configured to monitor the management table and delete a record that has not been updated during a certain period of time.

11. The radio base station according to claim 7, further comprising,
a management table timeout monitoring processor configured to monitor the management table and delete a record that has not been updated during a certain period of time.

12. The radio base station according to claim 8, further comprising,
a management table timeout monitoring processor configured to monitor the management table and delete a record that has not been updated during a certain period of time.
